(19) United States
(12) Patent Application Publication
(10) Pub. No.: US 2007/0236514 A1
(43) Pub. Date: Oct. 11, 2007

(54) Methods and Apparatuses for Stereoscopic Image Guided Surgical Navigation

(75) Inventors: Kusuma Agusanto, Singapore (SG); Chuanggui Zhu, Singapore (SG)

Correspondence Address: GREENBERG TRAURIG, LLP (SV);IP DOCKETING, 2450 COLORADO AVENUE, SUITE 400E, SANTA MONICA, CA, 90404, US

(73) Assignee: Bracco Imaging SPA, Milano (IT)

(21) Appl. No.: 11/277,920

(22) Filed: Mar. 29, 2006

(51) Int. Cl. G09G 5/00

(52) U.S. Cl. 345/646

(57) ABSTRACT

Methods and apparatuses to generate stereoscopic views for image guided surgical navigation. One embodiment includes transforming a first image of a scene into a second image of the scene according to a mapping between two views of the scene. Another embodiment includes generating a stereoscopic display of the scene using a first image and a second image of a scene during a surgical procedure, where a position and orientation of an imaging device is at least partially changed to capture the first and second images from different viewpoints. A further embodiment includes: determining a real time location of a probe relative to a patient during a surgical procedure; determining a pair of virtual viewpoints according to the real time location of the probe; and generating a virtual stereoscopic image showing the probe relative to the patient, according to the determined pair of virtual viewpoints.

### TECHNOLOGY FIELD

The present invention relates to image guided procedures in general and to providing stereoscopic images during a surgical navigation process in particular.

### BACKGROUND

During a surgical procedure, a surgeon cannot see beyond the exposed surfaces without the help from any visualization equipments. Within the constraint of a limited surgical opening, the exposed visible field may lack the spatial clues to comprehend the surrounding anatomic structures. Visualization facilities may provide the spatial clues which may not be otherwise available to the surgeon and thus allow Minimally Invasive Surgery (MIS) to be performed, dramatically reducing the trauma to the patient.

Many imaging techniques, such as Magnetic Resonance Imaging (MRI), Computed Tomography (CT) and three-dimensional Ultrasonography (3DUS), are currently available to collect volumetric internal images of a patient without a single incision. Using these scanned images, the complex anatomy structures of a patient can be visualized and examined; critical structures can be identified, segmented and located; and surgical approach can be planned.

The scanned images and surgical plan can be mapped to the actual patient on the operating table and a surgical navigation system can be used to guide the surgeon during the surgery.

U.S. Pat. No. 5,383,454 discloses a system for indicating the position of a tip of a probe within an object on cross-sectional, scanned images of the object. The position of the tip of the probe can be detected and translated to the coordinate system of cross-sectional images. The cross-sectional image closest to the measured position of the tip of the probe can be selected; and a cursor representing the position of the tip of the probe can be displayed on the selected image.

U.S. Pat. No. 6,167,296 describes a system for tracking the position of a pointer in real time by a position tracking system. Scanned image data of a patient is utilized to dynamically display 3-dimensional perspective images in real time of the patient's anatomy from the viewpoint of the pointer.

International Patent Application Publication No. WO 02/100284 A1 discloses a guide system in which a virtual image and a real image are overlaid together to provide visualization of augmented reality. The virtual image is generated by a computer based on CT and/or MRI images which are co-registered and displayed as a multi-modal stereoscopic object and manipulated in a virtual reality environment to identify relevant surgical structures for display as 3D objects. In an example of see through augmented reality, the right and left eye projections of the stereo image generated by the computer are displayed on the right and left LCD screens of a head mounted display. The right and left LCD screens are partially transparent such that the real world seen through the right and left LCD screens of the head mounted display is overlaid with the computer generated stereo image. In an example of microscope assisted augmented reality, the stereoscopic video output of a microscope is combined, through the use of a video mixer, with the stereoscopic, segmented 3D imaging data of the computer for display in a head mounted display. The crop plane used by the computer to generate the virtual image can be coupled to the focus plane of the microscope. Thus, changing the focus value of the microscope can be used to slice through the virtual 3D model to see details at different planes.

International Patent Application Publication No. WO 2005/000139 A1 discloses a surgical navigation imaging system, in which a micro-camera can be provided in a hand-held navigation probe. Real time images of an operative scene from the viewpoint of the micro-camera can be overlaid with computer generated 3D graphics, which depicts structures of interest from the viewpoint of the micro-camera. The computer generated 3D graphics are based on pre-operative scans. Depth perception can be enhanced through varying transparent settings of the camera image and the superimposed 3D graphics. A virtual interface can be displayed adjacent to the combined image to facilitate user interaction.

International Patent Application Publication No. WO 2005/000139 A1 also suggests that the real time images as well as the virtual images can be stereoscopic, using a dual camera arrangement.

Stereoscopy is a technique to provide three-dimensional vision. A stereoscopic image is typically based on a pair of images have two different viewpoints, each for one of the eyes of an observer such that the observer can have a sense of depth when viewing pair of images.

Many techniques have been developed to present the pair of images of a stereoscopic view so that each of the eyes of an observer can see one of the pair of images and thus obtain a sense of depth. The images may be presented to the eyes separately using a head mount display. The images may be presented at the same location (e.g., on the same screen) but with different characteristics, such that viewing glasses can be used to select the corresponding image for each of the eyes of the observer.

For example, the pair of images may be presented with differently polarized lights; and polarized glasses with corresponding polarizing filters can be used to select the images for the corresponding eyes. For example, the pair of images may be pre-filtered with color filters and combined as one anaglyph image; and anaglyph glasses with corresponding color filters can be used to select the images for the corresponding eyes. For example, the pair of images may be presented with different timing; and liquid crystal shutter glasses can be used to select the images for the corresponding eyes.

Alternatively, the pair of images may be displayed or printed in a side by side format for viewing, with or without the use of any additional optical equipment. For example, an observer may cause the eyes to cross or diverge so that each of the eyes sees a different one of the pair of images, without using any additional optical equipment, to obtain a sense of depth.

Therefore, there exists a need for an improved method and apparatus for generating stereoscopic views for image guided surgical navigation.

### SUMMARY OF THE DESCRIPTION

Methods and apparatuses to generate stereoscopic views for image guided surgical navigation are described herein. Some embodiments are summarized in this section.

One embodiment includes transforming a first image of a scene into a second image of the scene according to a mapping between two views of the scene.

Another embodiment includes generating a stereoscopic display of the scene using a first image and a second image of a scene during a surgical procedure, where a position and an orientation of an imaging device are at least partially changed to capture the first and second images from different viewpoints.

A further embodiment includes: determining a real time location of a probe relative to a patient during a surgical procedure; determining a pair of virtual viewpoints according to the real time location of the probe; and generating a virtual stereoscopic image showing the probe and the 3D model relative to the patient, according to the determined pair of virtual viewpoints.

Another embodiment includes: an imaging device; and a guiding structure coupled with the imaging device to constrain movement to change a viewpoint of the imaging device according to a path.

The present invention includes methods and apparatuses which perform these methods, including data processing systems which perform these methods, and computer readable media which when executed on data processing systems cause the systems to perform these methods.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIGS. 1-3 illustrate an augmented reality visualization system according to one embodiment of the present invention.

FIGS. 4-5 illustrate augmented reality images obtained from two different viewpoints, which can be used to construct stereoscopic displays according to embodiments of the present invention.

FIGS. 6-8 illustrate a method to construct a view mapping according to one embodiment of the present invention.

FIG. 9 illustrates a method to transform an image obtained at one viewpoint into an image at another viewpoint using a view mapping according to one embodiment of the present invention.

FIGS. 10-13 illustrate various stereoscopic images generated according to embodiments of the present invention.

FIGS. 14-19 illustrate various methods to obtain real time images to construct stereoscopic images generated according to embodiments of the present invention.

FIG. 20 shows a screen image with a grid for view mapping according to one embodiment of the present invention.

FIG. 21 shows a pair of images with warped grids, generated through texture mapping according to one embodiment of the present invention.

FIG. 22 shows the pair of images of FIG. 21, without the grids, which are generated through texture mapping for a stereoscopic view according to one embodiment of the present invention.

FIG. 23 shows a flow diagram of a method to generate a stereoscopic display according to one embodiment of the present invention.

FIG. 24 shows a flow diagram of a method to warp images according to one embodiment of the present invention.

FIG. 25 shows a flow diagram of a method to generate a stereoscopic display according to a further embodiment of the present invention.

FIG. 26 shows a block diagram example of a data processing system for generating stereoscopic views in image guided procedures according to one embodiment of the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description. References to one or an embodiment in the present disclosure can be, but not necessarily are, references to the same embodiment; and, such references mean at least one.

In one embodiment of the present invention, it is desirable to present stereoscopic images during a surgical navigation process to provide a sense of depth, which is helpful in positioning a device near or inside the patient during the surgical operation.

At least one embodiment of the present invention provides systems and methods for stereoscopic display of navigation information in an image-guided surgical procedure, based on generating a pair of images at two poses (position and orientation), according to location tracking data of a device. In one embodiment, the two poses, or viewpoints, have a predefined relation relative to the device. The device may be a navigation probe as used in surgical navigation systems, or an imaging device such as a video camera, an endoscope, a microscope, or a combination of imaging devices and/or a navigation probe.

In one embodiment, an imaging device such as a video camera is used to capture a sequence of images one pose a time. The imaging device can be moved around to obtain images captured at different poses. A data processing system is used to generate stereoscopic views based on the images captured by the imaging device.

According to one embodiment of the present invention, to generate a stereoscopic view, an image having one viewpoint can be transformed through warping and mapping to generate an image having another viewpoint for the generation of a pair of images for a stereoscopic view. Image warping may be used to generate one, or both, of the pair of images. The original image may be a real image captured using an imaging device during the surgical navigation process, or a virtual image rendered based on a tracked location of a navigation instrument.

In one embodiment, two images subsequently taken at two different poses of the same imaging device can be paired to generate a stereoscopic view, with or without performing image warping (e.g., to correct/shift viewpoints).

In one embodiment, virtual stereoscopic views are generated based on a 3D model of the subject of the surgical procedure (patient) and the tracked position of the device relative to the patient. The virtual stereoscopic views may be displayed without the real time images from an imaging device, such as a video camera, or overlaid with a non-stereoscopic real time image from an imaging device, or overlaid with a pseudo-stereoscopic image generated through image warping of a non-stereoscopic real time image.

Alternatively, two cameras, which may be identical, can be used on a navigation instrument to capture real time stereoscopic images. For example, two identical cameras can be mounted within the probe so that at each probe position a stereoscopic image can be generated.

In general, zero or more imaging devices, such as video camera, an endoscope, a microscope, may be mounted within a navigation instrument for a stereoscopic image guided navigation process.

In one embodiment, a micro video camera is mounted inside a probe; and a position tracking system is used to track the position and orientation of the probe, which can be used to determine the position and orientation of the micro video camera. A stereoscopic image of virtual objects, such as a planned surgical path or diagnosis/treatment information, can be mixed with a stereoscopic image of the surgical scene with correct overlay, based on the location data of the probe obtained from a position tracking system. As a result, video-based augmented reality can be displayed as stereoscopic views during the navigation process of the probe.

The stereoscopic augmented views can be displayed in a live, real time, interactive format, or as a series of still images or stereoscopic snapshots.

One embodiment of the present invention generates a real time augmented stereoscopic view using one real image captured at the current position of the probe. While the user points the tracked probe toward the target and moves the probe slowly and steadily, the system captures a real image and generates a pair of images corresponding to a pair of predefined left position and right position relative to the probe via warping and texture mapping. The system may further generate a pair of virtual images through rendering the virtual objects according to the same left and right positions, and mix the virtual and real images to create a pair of augmented images. In one embodiment, both the left and right images are generated in real time through image warping of the real image of the video camera. Alternatively, one of the left and right images may be the same as the real image from the video camera.

In one embodiment, the system produces a virtual stereoscopic image in a way as described above. The virtual stereoscopic image may be displayed without the real image, or mixed with a pseudo-stereoscopic real image (e.g., generated through imaging warping) or a stereoscopic real image (e.g., obtained at two different viewpoints). For example, the system may render one virtual image from the 3D model according to a left (or right) viewpoint, determine the image warping between the left and right viewpoints, and based on this warping, generate another virtual image for the right (or left) viewpoint via texture mapping of the rendered virtual image. Alternatively, the system may warp a rendered virtual image that has a center viewpoint of stereoscopic viewpoints to generate both the left and right images.

When the virtual stereoscopic image is displayed without the real image, the virtual stereoscopic image may show an image of a model of the probe and an image of a model of the target pointed to by the probe to show the positional relation between the target and the probe, based on the location tracking of the probe relative to the target.

A further embodiment of the invention produces a still augmented stereoscopic view using two real images taken from two poses of the device. For example, the user may point the tracked probe toward a target and provide a signal to identify a first viewpoint (e.g., based on the tracked location of the probe). The system captures the pose information of the tracked probe, which can be used to determine both the real viewpoint of the real camera and the virtual viewpoint of a virtual camera that correspond to the real camera. The system captures the real image while the probe is at this pose. From the pose information of the probe, the system calculates a second viewpoint according to a predefined rule, as specified by stereoscopic viewing parameters. For example, the first viewpoint may correspond to the left eye viewpoint; and the second viewpoint may correspond to the right eye viewpoint. The probe is then moved to the vicinity of the second viewpoint, so that the system can capture a further real image from the second viewpoint. The pair of real image can be augmented with a pair of virtual images to generate stereoscopic augmented views. Visual or sound information displayed or generated by the system to indicate the second viewpoint pose can be used to guide the tracked probe toward the second viewpoint. The resulting stereoscopic output can be displayed as a snapshot.

A further embodiment of the invention produces a real time augmented stereoscopic view using two real images captured from two viewpoints that have a predefined relation. The system produces an augmented view at the probe's current position and generates another augmented image based on a real image that is recorded a moment ago and that has a position relation to the probe's current position according to the predefined rule. The user may be guided in a similar manner as described above, using visual or sound information displayed or generated by the system to indicate the next desirable pose, while moving the probe.

In some cases, if the movement of the probe is not constrained, a previously recorded image meeting the predefined rule in position relation relative to the current position of the probe may not be found. Rather, a nearest match to the desired viewpoint may be used, with or without correction through image warping. The user may be trained or guided to move the probe in certain patterns to improve the quality of the stereoscopic view.

One embodiment of the present invention provides a mechanical guiding structure, in which the probe can be docked so that the probe can be moved along a pre-designed path relative to the guiding structure. The mechanical guiding structure allows the user to move the probe along a path to the next pose more precisely than to move the probe with a free hand, once the next post is pre-designed via the path. The path can be so designed that at least a pair of positions on the path correspond to two viewpoints that satisfy the pre-define spatial relation for taking a pair of real images for a stereoscopic view. Moving along the path in the mechanical guiding structure may change both the position and orientation of the probe; and the mechanical guiding structure can be adjustable to change the focal point of the pair of viewpoints and/or be pre-designed with multiple pairs of positions with different focal points.

In one embodiment, the mechanical guiding structure may be further docked into a mechanical supporting frame which may be attached to the patient surgical bed. The probe, or together with the mechanical guiding structure, can be adjusted to allow the user to change the stereoscopic target point of the probe. The mechanical guiding structure is moved relative to the target slower than the probe relative to the mechanical guiding structure, such that the mechanical guiding structure constrains the probe to be in the vicinity of one or more pairs of poses that are pre-designed to have pre-determined spatial relations for capturing images for stereoscopic views.

Alternatively, a mechanical guiding structure can be used within the probe to adjust the position and orientation of the imaging device (e.g., a micro video camera) relative to the probe to obtain images captured at different poses.

The probe or the imaging device may be moved automatically (e.g., motorized operation microscope).

In one embodiment of the present invention, image warping is determined based on a 3D model of the target. For example, a 3D model of the phantom can be constructed from the scan images and registered to the real phantom. When correctly registered, the projection of the 3D model of the phantom coincides with its corresponding real phantom in the real image. A predefined stereo configuration of virtual cameras can be associated with the probe (for example, having positions at 1.5 degree to left and right of the virtual camera in the probe, and looking at the tip of the probe). To determine the warping of the real image, for a point in the real image, the corresponding 3D point in the model can be identified. The 3D point can be used to compute the position of the point in the real image into its new position in the pair of real images by projecting it into the stereo image plane based on the stereo viewpoints. Thus, one embodiment of the present invention uses the warping properties determined from the 3D model of a real object in the image and a virtual camera, corresponding to the model of real camera, to transform/correct the captured real image from one viewpoint to a desired viewpoint.

Although the warping can be determined from the virtual image, it is not necessary to render a pair of virtual image to determine the warping properties. In one embodiment, the warping properties are determined from computing the projection of points of the 3D model that are seen in the original image into new positions as seen from the new, desired viewpoint.

A pair of virtual images of the phantom can thus be generated according to the 3D model of the phantom and the position and orientation of the probe. Since real images of the real phantom coincide with virtual images of the 3D model of the phantom, the warping between virtual images can be considered the same as the warping between a corresponding pair of real images.

The warping between two virtual images can be calculated from the position shift of corresponding pixels in the virtual images. In one embodiment of the present invention, an image is divided into small areas with a rectangular grid; and the warping properties of the pixels are calculated based on the position shift of the rectangular grid points. Texture mapping is used to map the pixels inside the grid areas to the corresponding positions. The width and height of the grids can be chosen to balance the stereo quality and computation cost. To compute the warping properties at the grid points, the system may compute the position shift in the corresponding virtual images for the points of the 3D phantom model that correspond to the grid points, without having to render the virtual images.

In one embodiment, the background behind the phantom is assigned a constant shift value (e.g., a value corresponding to 1 m away from the viewpoint) to make it appear far away from the interested area.

Further examples are provided below.

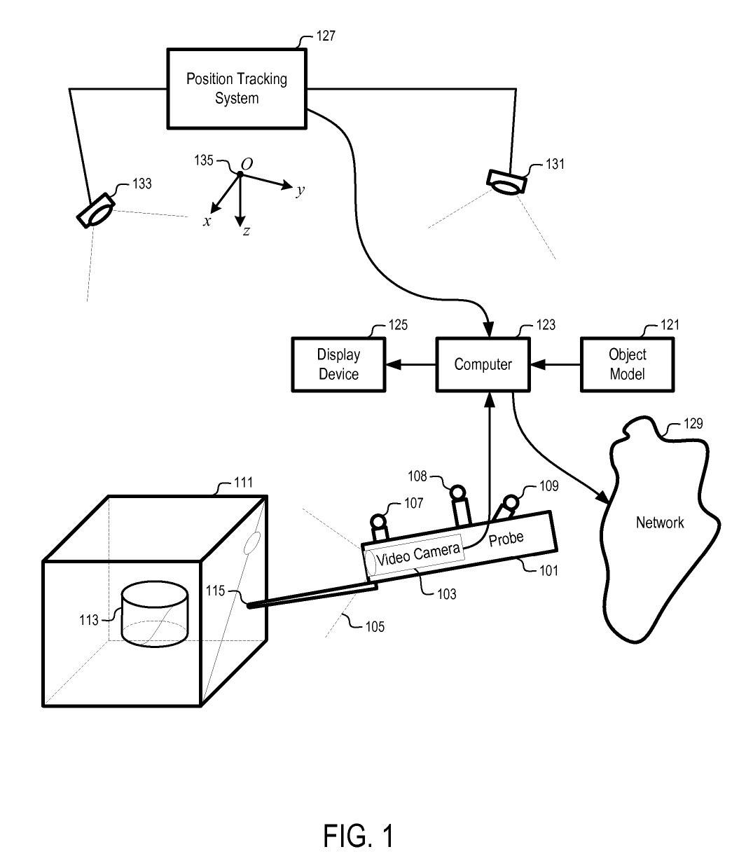

FIGS. 1-3 illustrate an augmented reality visualization system according to one embodiment of the present invention. In FIG. 1, a computer (123) is used to generate a virtual image of a view, according to a viewpoint of the video camera (103), to enhance the display of the reality based image captured by the video camera (103). The reality image and the virtual image are mixed in real time for display on the display device (125) (e.g., a monitor, or other display devices). The computer (123) generates the virtual image based on the object model (121) which is typically generated from scan images of the patient and defined before the image guided procedure (e.g., a neurosurgical procedure).

In FIG. 1, the video camera (103) is mounted on a probe (101) such that a portion of the probe, including the tip (115), is in the field of view (105) of the camera. The video camera (103) may have a known position and orientation with respect to the probe (101) such that the position and orientation of the video camera (103) can be determined from the position and the orientation of the probe (101).

In one embodiment, the image from the video camera is warped through texture mapping to generate at least one further image having a different viewpoint to provide a stereoscopic view. For example, the image from the video camera may be warped into the left and right images of the stereoscopic view, such that the stereoscopic view have an overall viewpoint consistent with the viewpoint of the image of the video camera. Alternatively, the image from the video camera may be used as the left (or right) image and a warped version of the video image is used as the right (or left) image. Alternatively, the image from the video camera may be warped to correct the viewpoint to a desired location so that the warped image can be paired with another image from the video camera for a stereoscopic display.

In one embodiment, images taken at different poses of the video camera are paired to provide stereoscopic display. The system may guide the video camera from one pose to another to obtain paired images that have desired viewpoints; alternatively, the system may automatically select a previous image, from a sequence of captured images, to pair with the current image for a stereoscopic display, according to stereoscopic view point requirement. The selected image and/or the current image may be further viewpoint corrected through image warping.

Alternatively, the probe (101) may not include a video camera. In general, images used in navigation, obtained pre -operatively or intraoperatively from imaging devices such as ultrasonography, MRI, X-ray, etc., can be the images of internal anatomies. To show a navigation instrument inside a body part of a patient, its position as tracked can be indicated in the images of the body part. For example, the system can: 1) determine and transform the position of the navigation instrument into the image coordinate system, and 2) register the images with the body part. The system determines the imaging device pose (position and orientation) (e.g., by using a tracking system) to transform the probe position to the image coordinate system.

In FIG. 1, the position and the orientation of the probe (101) relative to the object of interest (111) may be changed during the image guided procedure. The probe (101) may be hand carried and positioned to obtain a desired view. In some embodiments, the movement of the probe (101) may be constrained by a mechanical guiding structure; and the mechanical guiding structure may be hand adjusted and positioned to obtain a desired view. The probe (101) may be docked into a guiding structure to move relative to the guiding structure according to a pre-designed path.

In FIG. 1, the position and orientation of the probe (101), and thus the position and orientation of the video camera (103), is tracked using a position tracking system (127).

For example, the position tracking system (127) may use two tracking cameras (131 and 133) to capture the scene in which the probe (101) is. The probe (101) has features (107, 108 and 109) (e.g., tracking balls). The image of the features (107, 108 and 109) in images captured by the tracking cameras (131 and 133) can be automatically identified using the position tracking system (127). Based on the positions of the features (107, 108 and 109) of the probe (101) in the video images of the tracking cameras (131 and 133), the position tracking system (127) can compute the position and orientation of the probe (101) in the coordinate system (135) of the position tracking system (127).

The image data of a patient, including the various objects associated with the surgical plan which are in the same coordinate systems as the image data, can be mapped to the patient on the operating table using one of the generally known registration techniques. For example, one such registration technique maps the image data of a patient to the patient using a number of anatomical features (at least 3) on the body surface of the patient by matching their positions identified and located in the scan images and their corresponding positions on the patient determined using a tracked probe. The registration accuracy may be further improved by mapping a surface of a body part of the patient generated from the imaging data to the surface data of the corresponding body part generated on the operating table. Example details on registration may be found in U.S. patent application Ser. No. 10/480,715, filed Jul. 21, 2004 and entitled “Guide System and a Probe Therefor”, which is hereby incorporated herein by reference.

A reference frame with a number of fiducial points marked with markers or tracking balls can be attached rigidly to the interested body part of the patient so that the position tracking system (127) may also determine the position and orientation of the patient even if the patient is moved during the surgery.

The position and orientation of the object (e.g. patient) (111) and the position and orientation of the video camera (103) in the same reference system can be used to determine the relative position and orientation between the object (111) and the video camera (103). Thus, using the position tracking system (127), the viewpoint of the camera with respect to the object (111) can be tracked.

Although FIG. 1 illustrates an example of using tracking cameras in the position tracking system, other types of position tracking systems may also be used. For example, the position tracking system may determine a position based on the delay in the propagation of a signal, such as a radio signal, an ultrasound signal, or a laser beam. A number of transmitters and/or receivers may be used to determine the propagation delays to a set of points to track the position of a transmitter (or a receiver). Alternatively, or in combination, for example, the position tracking system may determine a position based on the positions of components of a supporting structure that may be used to support the probe.

Further, the position and orientation of the video camera (103) may be adjustable relative to the probe (101). The position of the video camera relative to the probe may be measured (e.g., automatically) in real time to determine the position and orientation of the video camera (103). In some embodiments, the movement of the video camera within the probe is constrained according to a mechanical guiding structure. Further, the movement of the video camera may be automated according to one or more pre-designed patterns.

Further, the video camera may not be mounted in the probe. For example, the video camera may be a separate device which may be tracked separately. For example, the video camera may be part of a microscope. For example, the video camera may be mounted on a head mounted display device to capture the images as seen by the eyes through the head mounted display device. For example, the video camera may be integrated with an endoscopic unit.

During the image guided procedure, the position and/or orientation of the video camera (103) relative to the object of interest (111) may be changed. A position tracking system is used to determine the relative position and/or orientation between the video camera (103) and the object (111).

The object (111) may have certain internal features (e.g., 113) which may not be visible in the video images captured using the video camera (103). To augment the reality based images captured by the video camera (103), the computer (123) may generate a virtual image of the object based on the object model (121) and combine the reality based images with the virtual image.

In one embodiment, the position and orientation of the object (111) correspond to the position and orientation of the corresponding object model after registration. Thus, the tracked viewpoint of the camera can be used to determine the viewpoint of a corresponding virtual camera to render a virtual image of the object model (121). The virtual image and the video image can be combined to display an augmented reality image on display device (125).

In one embodiment of the present invention, the data used by the computer (123) to generate the display on the display device (125) is recorded such that it is possible to regenerate what is displayed on the display device (125), to generate a modified version of what is displayed on the display device (125), to transmit data over a network (129) to reconstruct what is displayed on the display device (125) while avoiding affecting the real time processing for the image guided procedure (e.g., transmit with a time shift during the procedure, transmit in real time when the resource permits, or transmit after the procedure). Detailed examples on recording a surgical navigation process may be found in a co-pending U.S. patent application Ser. No. 11/374,684, entitled “Methods and Apparatuses for Recording and Reviewing surgical navigation processes” and filed Mar. 13, 2006, which is hereby incorporated herein by reference. Example details on a system to display over a network connection may be found in Provisional U.S. Patent Application No. 60/755,658, filed Dec. 31, 2005 and entitled “Systems and Method for Collaborative Interactive Visualization Over a Network”, which is hereby incorporated herein by reference.

The 3D model may be generated from three-dimensional (3D) images of the object (e.g., bodies or body parts of a patient). For example, a MRI scan or a CAT (Computer Axial Tomography) scan of a head of a patient can be use in a computer to generate a 3D virtual model of the head.

Different views of the virtual model can be generated using a computer. For example, the 3D virtual model of the head may be rotated seemly in the computer so that another point of view of the model of the head can be viewed; parts of the model may be removed so that other parts become visible; certain parts of the model of the head may be highlighted for improved visibility; an interested area, such as a target anatomic structure, may be segmented and highlighted; and annotations and markers such as points, lines, contours, texts, labels can be added into the virtual model.

In a scenario of surgical planning, the viewpoint is fixed, supposedly corresponding to the position(s) of the eye(s) of the user; and the virtual model is movable in response to the user input. In a navigation process, the virtual model is registered to the patient and is generally still. The camera can be moved around the patient; and a virtual camera, which may have the same viewpoint, focus length, field of view etc, position and orientation as of the real camera, is moved according to the movement of the real camera. Thus, different views of the object is rendered from different viewpoints of the camera.

Viewing and interacting virtual models generated from scanned data can be used for planning the surgical operation. For example, a surgeon may use the virtual model to diagnose the nature and extent of the medical problems of the patient, and to plan the point and direction of entry into the head of the patient for the removal of a tumor to minimize damage to surrounding structure, to plan a surgical path, etc. Thus, the model of the head may further include diagnosis information (e.g., tumor object, blood vessel object), surgical plan (e.g., surgical path), identified landmarks, annotations and markers. The model can be generated to enhance the viewing experience and highlight relevant features.

During surgery, the 3D virtual model of the head can be used to enhance reality based images captured from a real time imaging device for surgery navigation and guidance. For example, the 3D model generated based on preoperatively obtained 3D images produced from MRI and CAT (Computer Axial Tomography) scanning can be used to generate a virtual image as seen by a virtual camera. The virtual image can be superimposed with an actual surgical field (e.g., a real-world perceptible human body in a given 3D physical space) to augment the reality (e.g., see through a partially transparent head mounted display), or mixed with a video image from a video camera to generate an augmented reality display. The video images can be captured to represent the reality as seen. The video images can be recorded together with parameters used to generate the virtual image so that the reality may be reviewed later without the computer generated content, or with a different computer generated content, or with the same computer generated content.

In one embodiment, the probe (101) may not have a video camera mounted within it. The real time position and orientation of the probe (101) relative to the object (111) can be tracked using the position tracking system (127). A pair of viewpoints associated with the probe (101) can be determined to construct a virtual stereoscopic view of the object model (121), as if a pair of virtual cameras were at the viewpoints associated with the probe (101). The computer (123) may generate a real time sequence of stereoscopic images of the virtual view of the object model (121) for display on the display device to guide the navigation of the probe (101).

Further, image based guidance can be provided based on the real time position and orientation relation between the object (111) and the probe (101) and the object model (121). For example, based on the known geometric relation between the viewpoint and the probe (101), the computer may generate a representation of the probe (e.g., using a 3D model of the probe) to show the relative position of the probe with respect to the object.

For example, the computer (123) can generate a 3D model of the real time scene having the probe (101) and the object (111), using the real time determined position and orientation relation between the object (111) and the probe (101), a 3D model of the object (111), and a model of the probe (101). With the 3D model of the scene, the computer (123) can generate a stereoscopic view of the 3D model of the real time scene for any pairs of viewpoints specified by the user. Thus, the pose of the virtual observer with the pair of viewpoints associated with the eyes of the virtual observer may have a pre-determined geometric relation with the probe (101), or be specified by the user in real time during the image guided procedure.

In one embodiment, information indicating the real time location relation between the object (111) and the probe (101) and the real time viewpoint for the generation of the real time display of the image for guiding the navigation of the probe is recorded so that, after the procedure, the navigation of the probe may be reviewed from the same sequence of viewpoints, or from different viewpoints, with or without any modifications to the 3D model of the object (111) and the model of the probe (101).

In one embodiment, the location history and/or the viewpoint history for at least the most recent time period are cached in memory so that the system may search the history information to find a previously captured or rendered image that can be paired with the current image to provide a stereoscopic view.

Note that various medical devices, such as endoscopes, can be used as a navigation instrument (e.g., a probe) in the navigation process.

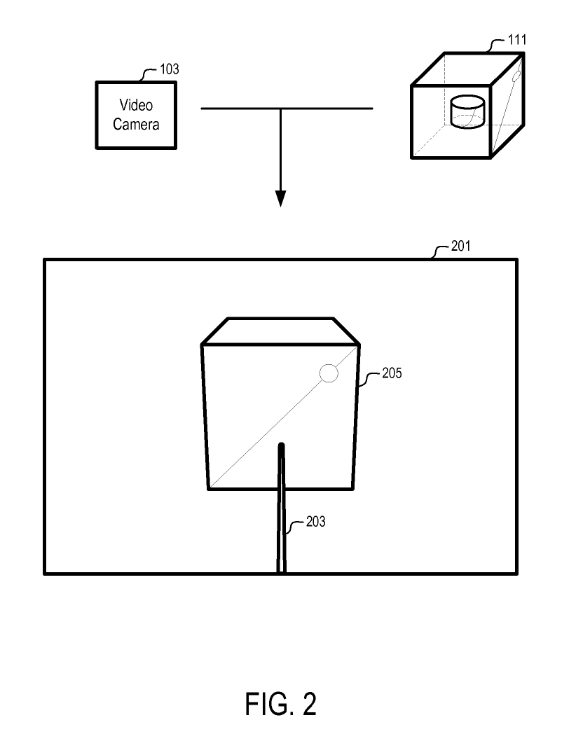

In FIG. 2, a video camera (103) captures a frame of a video image (201) which shows on the surface features of the object (111) from a view point that is tracked. The image (201) includes an image of the probe (203) and an image of the object (205).

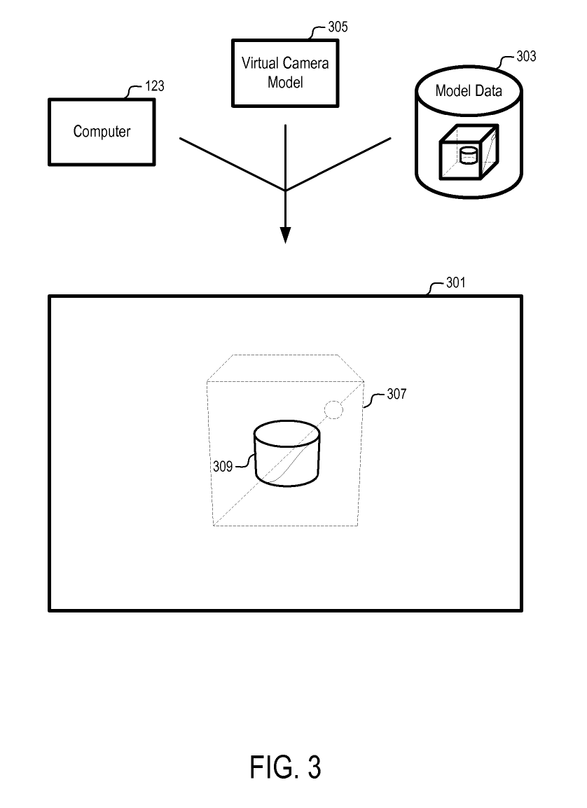

In FIG. 3, a computer (123) uses the model data (303), which may be a 3D model of the object (e.g., generated based on volumetric imaging data, such as MRI or CT scan), and the virtual camera (305) to generate the virtual image (301) as seen by a virtual camera. The virtual image (301) includes an internal feature (309) within the object (307). The sizes of the images (201 and 301) may be the same.

A virtual image may also include a virtual object associated with the real object according to a 3D model. The virtual object may not correspond to any part of the real object in the real time scene. For example, a virtual object may be a planned surgical path, which may not exist during the surgical procedure.

In one embodiment, the virtual camera is defined to have the same viewpoint as the video camera such that the virtual camera has the same viewing angle and/or viewing distance to the 3D model of the object as the video camera to the real object. The virtual camera has the same imaging properties and pose (position and orientation) as the actual video camera. The imaging properties may include focal length, field of view and distortion parameters. The virtual camera can be created from calibration data of the actual video camera. The calibration data can be stored in the computer. The computer (123) selectively renders the internal feature (113) (e.g., according to a user request). For example, the 3D model may contain a number of user selectable objects; and one or more of the objects may be selected to be visible based on a user input or a pre-defined selection criterion (e.g., based on the position of the focus plane of the video camera).

The virtual camera may have a focus plane defined according to the video camera such that the focus plane of the virtual camera corresponding to the same focus plane of the video camera, relative to the object. Alternatively, the virtual camera may have a focus plane that is a pre-determined distance further away from the focus plane of the video camera, relative the object.

The virtual camera model may include a number of camera parameters, such as field of view, focal length, distortion parameters, etc. The generation of virtual image may further include a number of rendering parameters, such as lighting condition, color, and transparency. Some of the rendering parameters may correspond to the settings in the real world (e.g., according to the real time measurements), some of the rendering parameters may be pre-determined (e.g., pre-selected by the user), some of the rendering parameters may be adjusted in real time according to the real time user input.

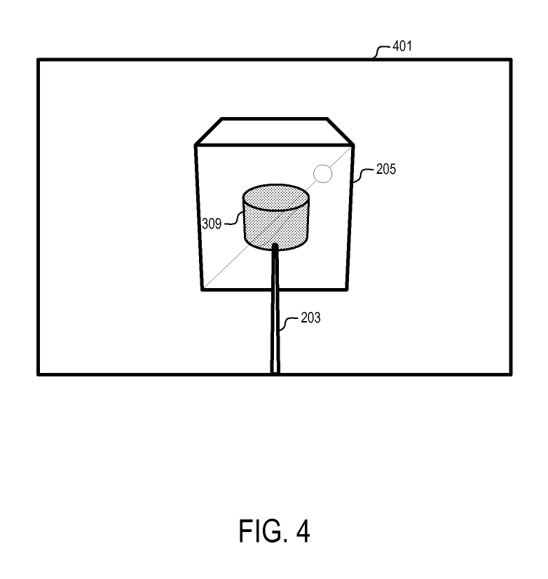

The video image (201) in FIG. 2 and the computer generated image (301) in FIG. 3, as captured by the virtual camera, can be combined to show the image (401) of augmented reality in real time, as illustrated in FIG. 4. In exemplary embodiments according to the present invention, the augmented reality image can be displayed in various ways. The real image can be overlaid on the virtual image (real image is on the virtual image), or be overlaid by the virtual image (the virtual image is on the real image). The transparency of the overlay image can be changed so that the augmented reality image can be displayed in various ways, with the virtual image only, real image only, or a combined view. At the same time, for example, axial, coronal and sagittal planes of the 3D models according to the position changing of the focal point can be displayed in three separate windows.

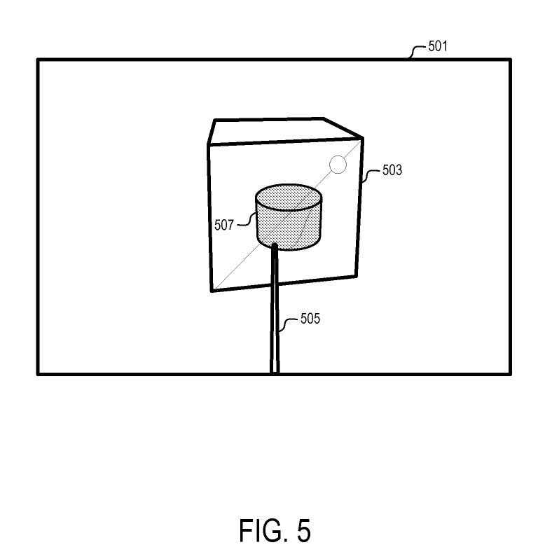

When the position and/or the orientation of the video camera (103) is changed, the image captured by the virtual camera is also changed; and the combined image (501) of augmented reality is also changed, as shown in FIG. 5.

In one embodiment of the present invention, the images (401 and 501) are paired to provide a stereoscopic view, when the viewpoints of the images meet the pre-defined requirement for a stereoscopic image (exactly or approximately).

In one embodiment, a virtual object which is geometrically the same, or approximately the same, as the real object seeing by the actual camera is used to apply image warping to real image. For example, to warp the real image of a head, a model of the head surface (e.g. 3D model reconstructed from volumetric data) is registered to the head. Based on the model of the head surface, the real image that is obtained at one of the two viewpoints can be warped into an image according to the other one of the two viewpoints. In embodiments of the present invention, the image warping technique can be used to shift or correct the viewpoint of a real image to generate one or more images at desired viewpoints.

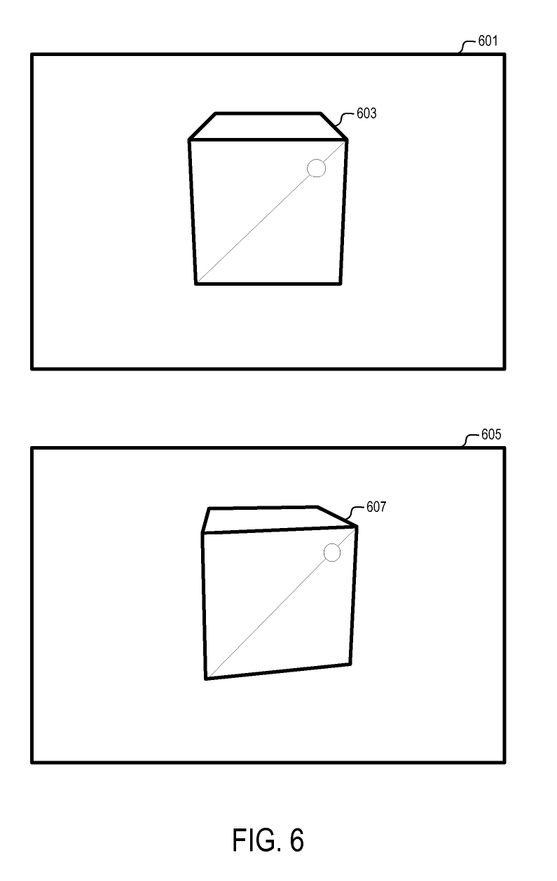

FIGS. 6-8 illustrate a method to construct a view mapping according to one embodiment of the present invention. In FIG. 6, the virtual image (601) correspond to a real image (201) taken at a given viewpoint. According to the required stereoscopic viewpoint relations, the virtual image (605) taken at another viewpoint for the stereoscopic display can be computed from the 3D model. Since the virtual images (601 and 605) show slightly different images (603 and 607) of the object of interest, the virtual image (605) can be considered as a warped version of the virtual image (601).

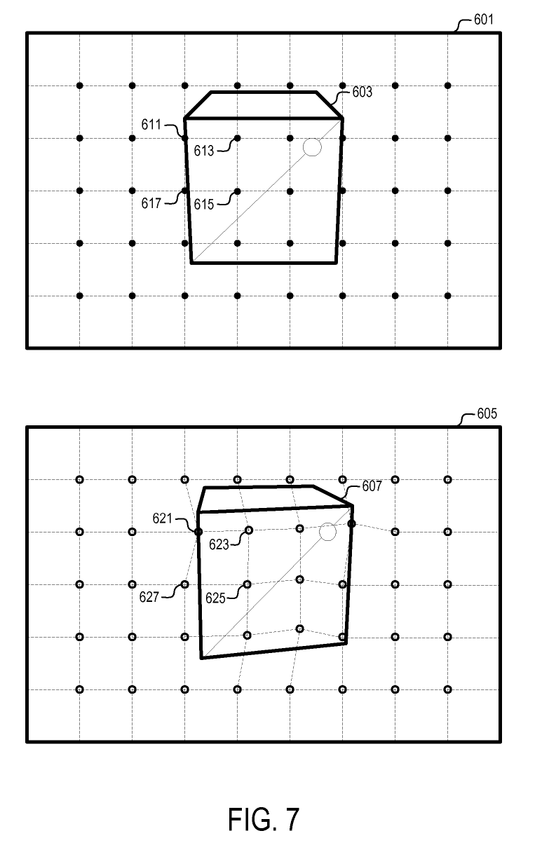

In one embodiment, a grid as shown in FIG. 7 is used to compute the warping properties. The grid points (e.g., 611, 613, 615, 617) in the image (601) at one viewpoint may move to positions at the corresponding points (e.g., 621, 623, 625, 627) in the image (605) at another viewpoint. The position shift can be computed from the 3D model and the viewpoints without having to render the virtual images (601 and 605).

For example, the position shift can be calculated by: 1) using a grid point (2D) to identify a corresponding point (model point, 3D) on the 3D model; 2) determining the image positions of the model point in the current image and the image at the desired viewpoint. 3) calculating the difference between the image positions at the two different viewpoints. For example, ray casting can be used to shot a ray from the viewpoint, passing though the grid point, at a point on the 3D object to determine the corresponding point on the 3D model. The exact point hit by the ray can be used as the model point. Alternatively, if the virtual object is a cloud point object, the visible closest point to the ray can be selected as the model point; if the virtual object is a mesh object, the vertex closest to the ray can be selected as the model point. When the model point is not the exact point hit at by the ray, the image point may not be exactly on the grid point.

In one embodiment, the warping is determined to generate one virtual image from another, when image warping can be done faster than rendering the entire virtual image (e.g., when the scene involves complex illumination computation and huge 3D model data such that it is much faster to compute the intersection of the ray in the 3D model shot from the grid points and do texture mapping).

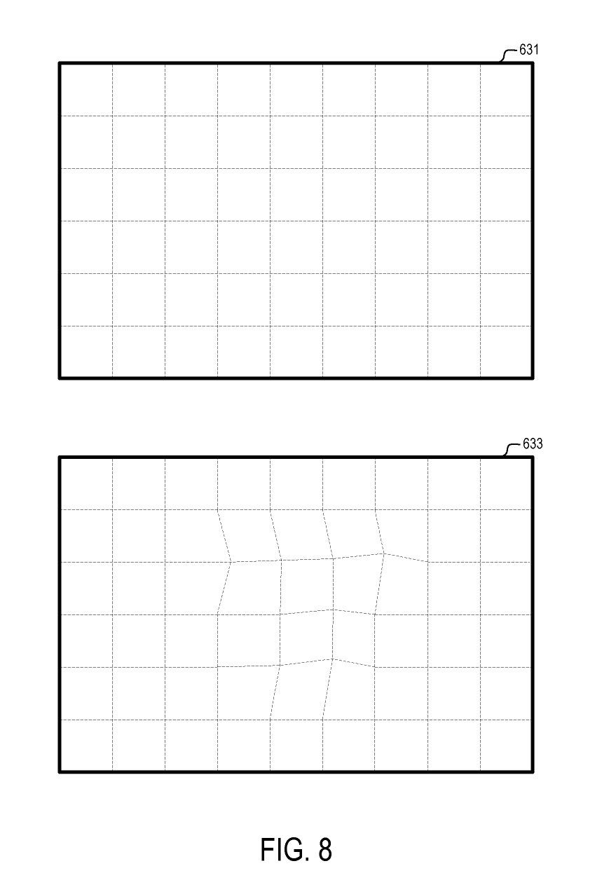

Thus, based on the position shift of the grid points, the image warping between the two viewpoints can be computed, as illustrated by the grids (631 and 633) shown in FIG. 8.

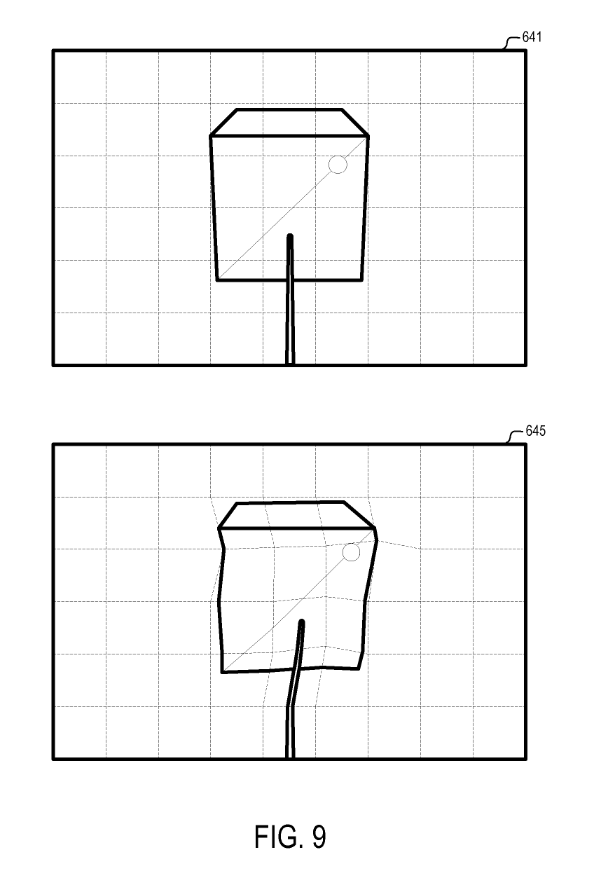

FIG. 9 illustrates a method to transform an image obtained at one viewpoint into an image at another viewpoint using a view mapping according to one embodiment of the present invention.

Based on the grid points, an image in one of the viewpoints can be warped through texture mapping into an image in another one of the viewpoints, as illustrated in FIG. 9. For example, each grid cell as defined by four grid points can be mapped from the top image (641) to the bottom image (645) in FIG. 9 to generate the bottom image (645). Texture mapping can be performed very efficiently using a graphics processor.

In FIG. 9, the real image (641) taken from the video camera is warped to generate the image (645) that approximates the real image to be taken at the corresponding viewpoint for the stereoscopic view.

In the above examples, a regular rectangular grid (e.g., as sample means) is used for the image that is to be transformed or warped. Alternatively, a non-regular rectangular grid can be used for the image that is to be generated, such that the grid on the image that is to be transformed or warped is non-regular. For example, one may warp the image (605) to generate an approximated version of the image (601).

Although a regular rectangular grid is illustrated in some examples of the description, other types of regular or non-regular grids can also be used. For example, the system may perform an edge detection operation and generate a non-regular mesh based on the detected edges. Alternatively, or in combination, a non-regular grid or mesh can also be generated based on the 3D model information (e.g., shape of the surface polygons).

In the above examples, the virtual images include the target object but not the probe. To obtain an improved mapping for image warping, the virtual images may further include the probe and/or other objects in the scene, based on the 3D model of these objects. The finer the grid, the better is the quality of the warped images, although computation cost also increases when the grid is increasingly refined. Alternatively, an adaptive mesh can also provide a better quality of warped images, with number of point grids similar to the regular grid. For example, a group of grids having less or no features in 3D model (e.g. a smooth surface) can be combined into a bigger, coarser grid; and a grid having more features (e.g. edges) can be subdivided into smaller, finer grids to accommodate these features for warping.

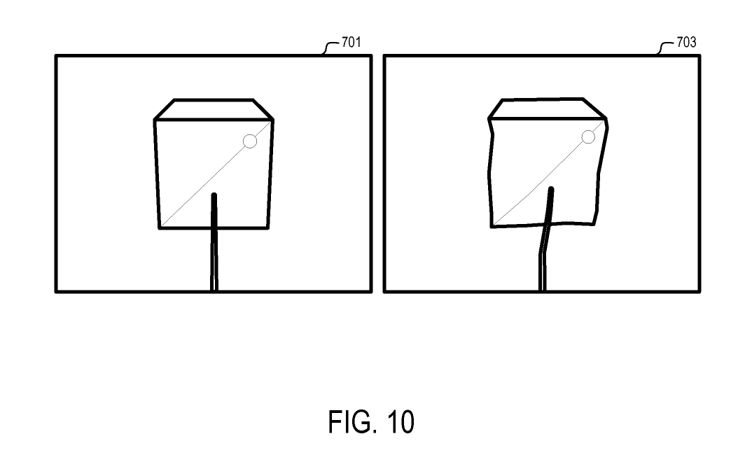

FIGS. 10-13 illustrate various stereoscopic images generated according to embodiments of the present invention. The stereoscopic images are illustrated here in a side by side format. However, various different display and viewing techniques known in the art can also be used to present stereoscopic images for viewing in a surgical navigation process. For example, a pair of images can be used to generate an anaglyph image for viewing via anaglyph glasses, or be presented to different eyes via a head mount display.

FIG. 10 illustrates a stereoscopic image of a real scene, in which the right image (703) is obtained through warping the left image (701). Alternatively, both left and right images may be generated from warping an original image captured at a viewpoint between the viewpoints of the stereoscopic image, such that the overall viewpoint of the stereoscopic image is consistent with the viewpoint of the original image.

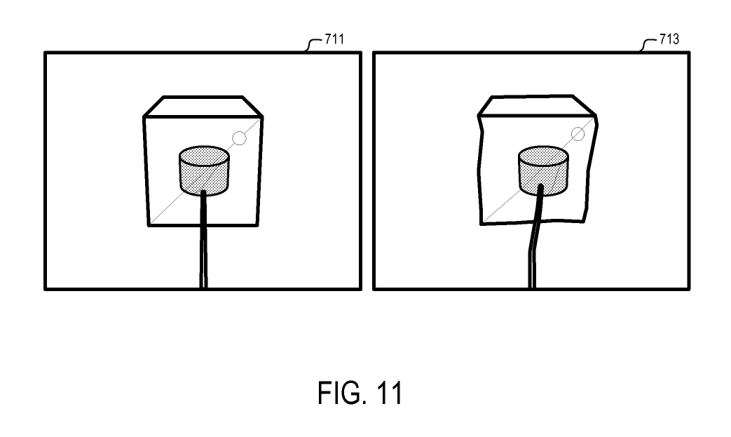

FIG. 11 illustrates a stereoscopic augmented reality image, in which the right real image is obtained through warping the left real image. The left and right images (711 and 713) are augmented with a stereoscopic virtual image generated from a 3D model. In one embodiment, both virtual images are directly rendered from the 3D model. Alternatively, one of the virtual images is generated through warping the other virtual image. Alternatively, both of the virtual images may be generated through warping a virtual image rendered at the center of the two viewpoints of the stereoscopic view.

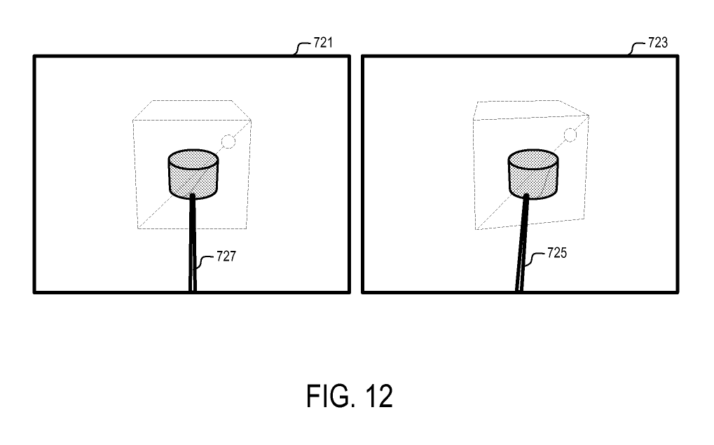

FIG. 12 illustrates a stereoscopic virtual image (721 and 723), which shows also the stereoscopic image (727 and 725) of the probe based on a 3D model of the probe. The stereoscopic virtual image may include a portion obtained from a real image. Portions of the stereoscopic virtual image can be generated through image warping. For example, the stereoscopic image (727 and 725) of the probe may be rendered and reused in different stereoscopic images; a portion of the target that is near the tip of the probe may be rendered directly from a 3D image data set; and the remaining portion of the target of one or both of the images may be generated from image warping.

In one embodiment, the stereoscopic virtual image is mixed with a stereoscopic real image from warping for an augmented reality display. Alternatively, the same stereoscopic real image may be overlaid with the stereoscopic virtual image.

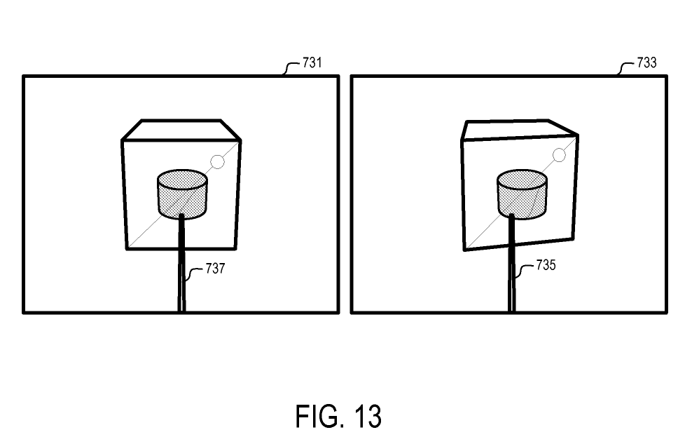

FIG. 13 illustrates a stereoscopic augmented image (731 and 733), which are based on two real images captured by the probe at two different poses. Since the camera has a fixed relative position with respect to the probe, the probe has the same position (737 and 735) in the images (731 and 733). The position of the probe would be different if the real images were captured by a pair of cameras simultaneously. Thus, the stereoscopic augmented image (731 and 733) as illustrated in FIG. 13 is also an approximated version, since the probe positions in the real scene are different in the stereoscopic augmented image (721 and 723). Alternatively, the real image may not include the tip of the probe; and a stereoscopic image of the probe rendered based on a 3D model of the probe can be overlaid with real image to show the relative position between the probe and the target.

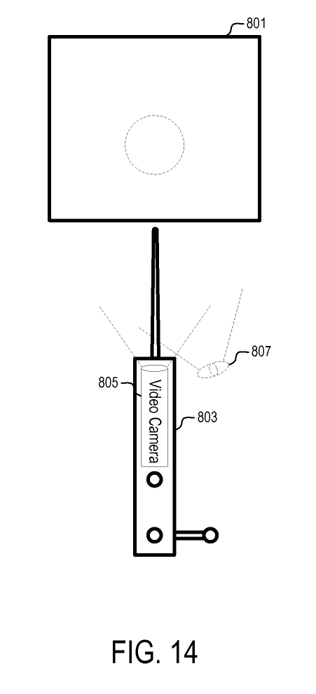

FIGS. 14-19 illustrate various methods to obtain real time images to construct stereoscopic images generated according to embodiments of the present invention.

In FIG. 14, a micro video camera (805) is housed inside the probe (803). The video camera (805) takes a real time image at one viewpoint; and through image warping, a computer system generates corresponding real time images at another viewpoint (807) that has a pre-defined spatial relation with the probe (803), such that a stereoscopic view of the object (801) can be generated in real time using the single video camera (805).

In the example of FIG. 14, the stereoscopic view is not along the probe. To show the stereoscopic view along the probe, the video camera may be mounted in an angle with respect to the probe, so that the probe is on the symmetric line between the viewpoint of the camera and the other viewpoint.

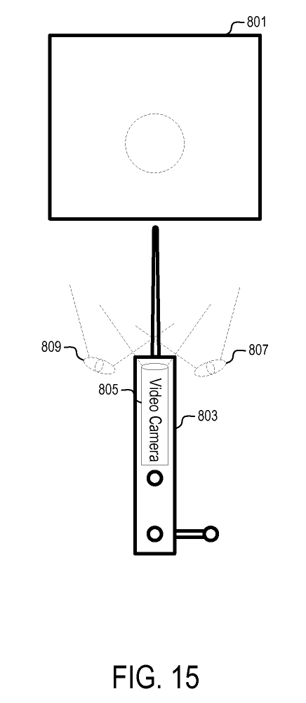

In FIG. 15, each of the viewpoints (807 and 809) of the stereoscopic image does not coincide with the viewpoint of the video camera (805). The viewpoints (807 and 809) are symmetric about the viewpoint of the video camera (805), such that as a whole the stereoscopic image has a view point consistent with the viewpoint of the video camera (805). The system generates both the left and right images from warping the video image obtained from the video camera (805).

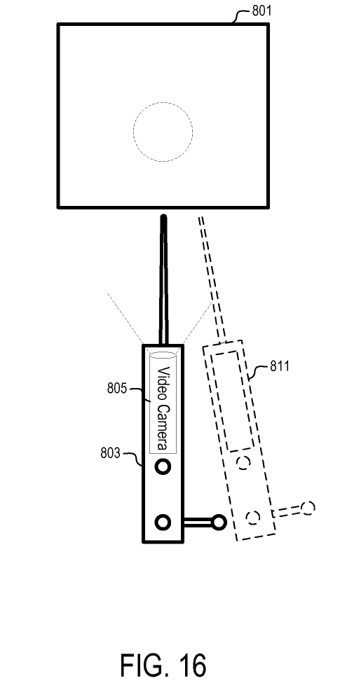

In FIG. 16, the video camera takes an image while the probe is at the position (811) and another image while the probe is at the position (803). These two images can be paired to obtain an approximated stereoscopic image, as if there were taken from two video cameras: one at the position (811) and the other at the position (803). However, since the probe is at different positions when taking the two images, the probe portions of the scenes captured in the two images are identical. The pairs of the images have correct stereoscopic relations for the object portions of the images, but not for the probe portions of the images.

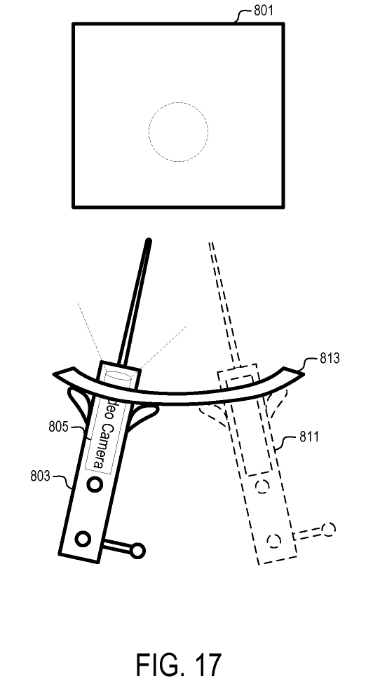

In FIG. 17, the probe (803) housing the video camera (805) is movable within the constraint of a mechanical guiding structure (813). A user may move the mechanical guiding structure (813) slowly to change the overall viewpoint; and the probe (803) can be moved more rapidly within the constraint of the mechanical guiding structure (813) to obtain pairs of images for stereo display. The mechanical guiding structure may further include switches or sensors which provide signals to the computer system when the probe is at a desired pose.

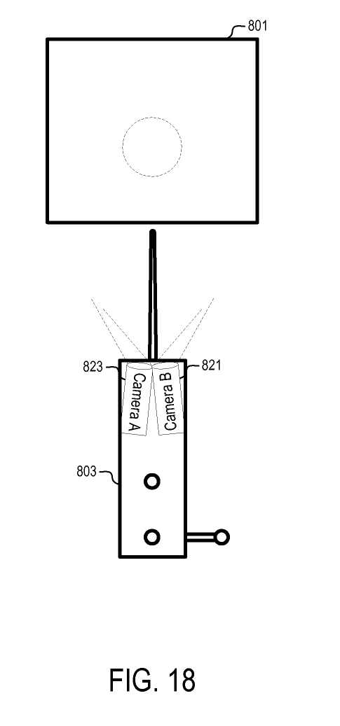

FIG. 18 illustrates an arrangement in which two video cameras (821 and 823) can be used to capture a stereoscopic pair of images of the scene, including the tip of the probe, at one position of the probe (803). A stereoscopic display may be based on the viewpoints of the pair of video cameras. Alternatively, the stereoscopic pair of images may be further mapped from the viewpoints of the cameras to desired virtual viewpoints for stereoscopic display. For example, the texture mapping techniques described above can be used to adjust the stereo base (the distance between the viewpoints of the stereoscopic display).

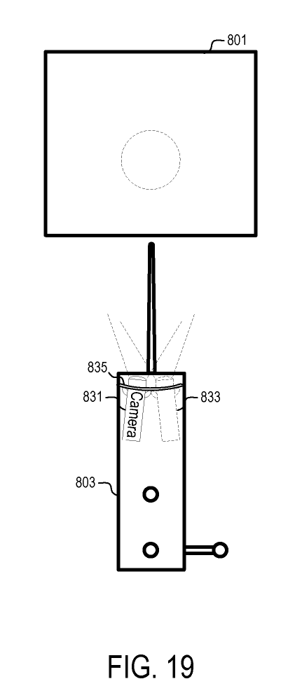

FIG. 19 illustrates an arrangement in which a single video camera (831) can be moved within the probe (803) to obtain images of different viewpoints for stereo display. A mechanical guiding structure (835) is used to constrain the movement of the video camera, such that stereoscopic pairs of images can be readily selected from the stream of video images obtained from the video camera. The camera may be moved using a motorized structure to remove from the user the burden of controlling the video camera movement within the probe. The position and orientation of the camera relative to the probe (803) can be determined or tracked based on the operation of the motor.

Alternatively, the video camera may be mounted outside the probe and movable relative to the probe. A guiding structure can be used to support the video camera relative to the probe.

The guiding structure may include a motor to automatically move the video camera relative to the probe according to one or more pre-designed patterns. When the probe is stationary relative to the target (or moved slowly and steadily), the video camera can be moved by the guiding structure to take real world images from different viewpoints. The position of the probe relative to the probe can tracked based on the state of the motor and/or one or more sensors coupled to the guiding structure. For example, the movement of a microscope can be motor driven; and a stereoscopic image can be obtained by moving the microscope to the desired second position.

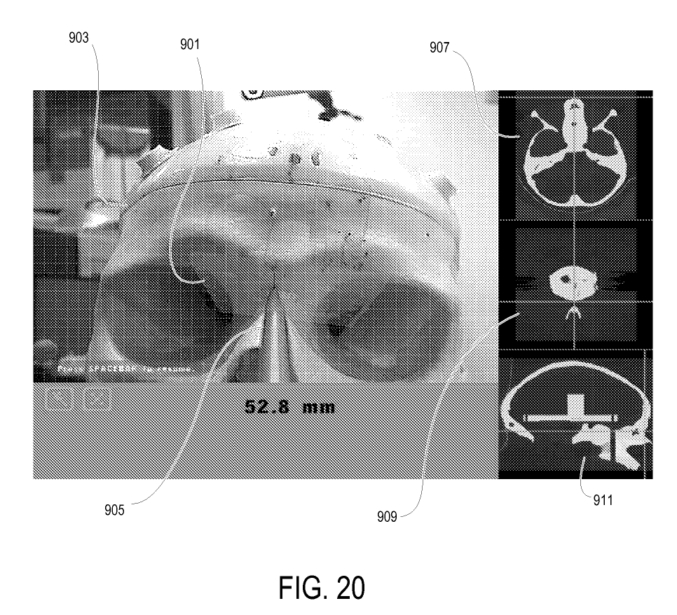

FIG. 20 shows a screen image with a grid for view mapping according to one embodiment of the present invention. In FIG. 20, the display screen shows a 3D view of a phantom (903) with a number of virtual objects (e.g., 901) and the probe (905). Three cross-sectional views are displayed in separate portions (907, 909, and 911) of the display screen. The distance between the probe and the phantom is computed and displayed (e.g., 0.0 mm).

FIG. 20 shows a rectangular grid used to compute the warping property and the non-stereoscopic display of the augmented reality. In one embodiment, the non-stereoscopic display can be replaced with an anaglyph image of a stereoscopic view generated according to embodiments of the present invention.

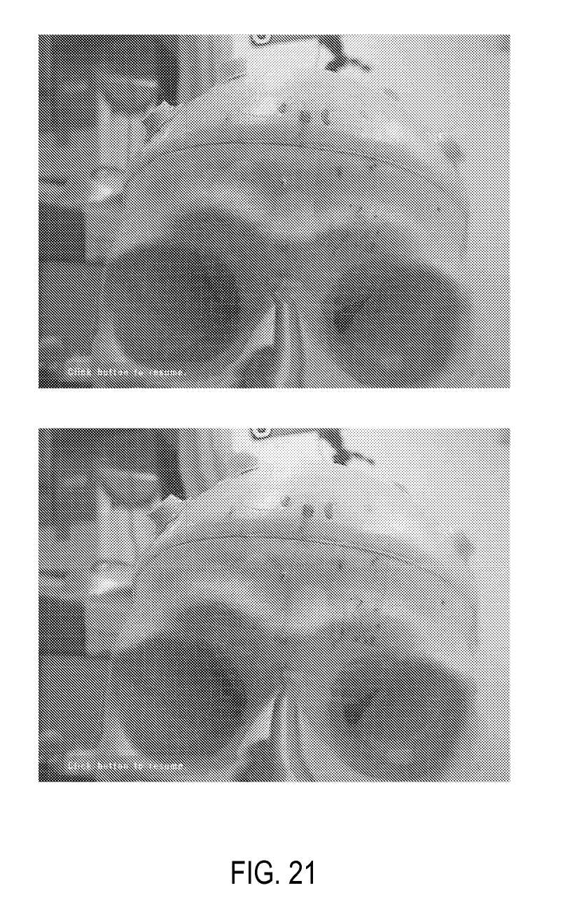

FIG. 21 shows a pair of images with warped grids, generated through texture mapping according to one embodiment of the present invention. In FIG. 21, both the left and right images are generated from image warping. The warping of the grid is determined through identifying the points in the 3D model that are shown as the grid points in the camera image as illustrated in FIG. 20 and determining the positions of these points in the left and right images as illustrated in FIG. 21. Texture mapping is then used to warp the camera image as illustrated in FIG. 20 into the left and right images illustrated in FIG. 21.

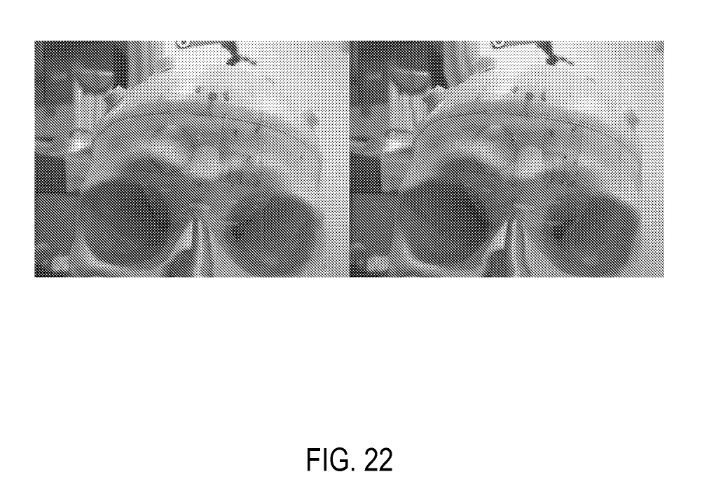

FIG. 22 shows the pair of images of FIG. 21, without the grids, which are generated through texture mapping for a stereoscopic view according to one embodiment of the present invention. In FIG. 22, the augmented stereoscopic view is illustrated in a side by side format. In one embodiment, a stereoscopy view is displayed as an anaglyph image, which is a combination of the left and right images that are filtered with different color filters (e.g., red and cyan). The filtering can be achieved through manipulating the RGB (Red Green Blue) values of pixels of the image. The anaglyph image can be displayed on a monitor and viewed through a pair of anaglyph glasses.

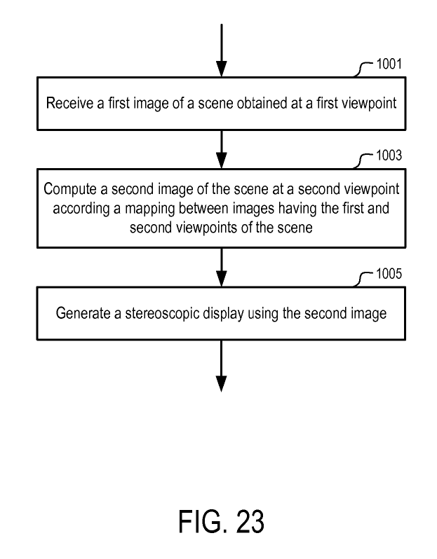

FIG. 23 shows a flow diagram of a method to generate a stereoscopic display according to one embodiment of the present invention. In FIG. 23, after a first image of a scene obtained at a first viewpoint is received (1001), a second image of the scene at a second viewpoint is computed (1003) according a mapping between images having the first and second viewpoints of the scene. A stereoscopic display is generated (1005) using the second image. The first image may be a real image, a virtual image, or an augmented image.

For example, the stereoscopic display may be from the first and second viewpoints of the scene; and the first and second images can be paired to generate the stereoscopic display.

For example, the stereoscopic display may be from the second viewpoint and a third viewpoint of the scene; the first viewpoint is in the vicinity of the second viewpoint. The first image is corrected from the first viewpoint to the second viewpoint such that the second image can be paired with an image having the third viewpoint to provide a stereoscopic view.

For example, the first image may be further transformed to generate a third image at a third viewpoint of the scene; and the second and third image can be paired to provide a stereoscopic view of the scene. Further, in this example the viewpoints of the second and third images may be symmetric about the first viewpoint such that the center of the second and third viewpoints coincides with the first viewpoint.

The first image may be an image obtained from imaging device, such as a video camera, an endoscope, or a microscope. The imaging device captures images of the real world scene. Alternatively, the first image may be rendered from a 3D model of the scene. The 3D model may be generated from scanned image obtained from modalities such as MRI, X-ray, CT, 3DUS, etc. The first image may include one or more virtual objects which may not be in the real world scene. Alternatively, the first image may be a combination of a real image obtained from an imaging device and a virtual image rendered from a 3D model.

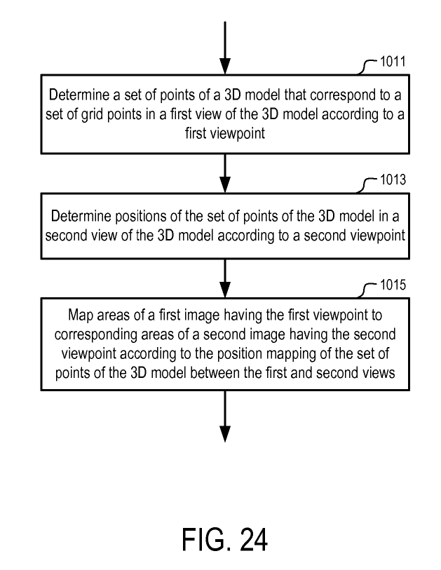

FIG. 24 shows a flow diagram of a method to warp images according to one embodiment of the present invention. In FIG. 24, a set of points in a 3D model that correspond to a set of grid points of a first view of the 3D model is determined (1011) according to a first viewpoint. Positions of the set of points in the 3D model of a second view of the 3D model are determined (1013) according to a second viewpoint. Areas of a first image having the first viewpoint can be mapped (1015) to corresponding areas of a second image having the second viewpoint according to the position mapping of the set of points of the 3D model between the first and second views.

Alternatively, areas of a second image having the second viewpoint can be mapped (1015) to corresponding areas of a first image having the first viewpoint according to the position mapping of the set of points of the 3D model between the first and second views.

The grid points may be on a regular rectangular grid in the first view, or an irregular grid. The mapping can be performed using a texture mapping function of a graphics processor.

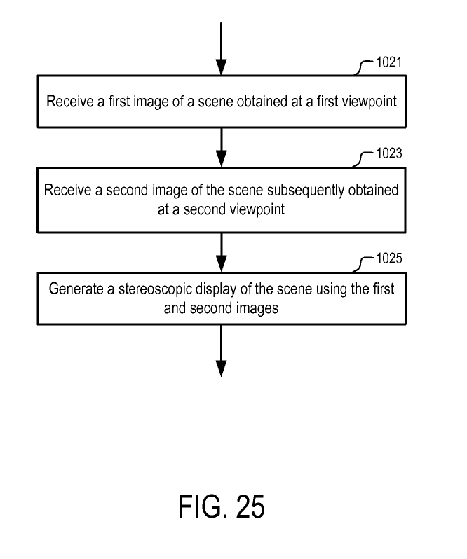

FIG. 25 shows a flow diagram of a method to generate a stereoscopic display according to a further embodiment of the present invention. A first image of a scene obtained at a first viewpoint is received (1021). Subsequently, a second image of the scene obtained at a second viewpoint is received (1023). A stereoscopic display of the scene is then generated (1025) using the first and second images.

For example, the first image may be taken when the imaging device (e.g., a video camera mounted on a probe) is at the first viewpoint. The image device is then moved to the second viewpoint to take the second image. The movement of the imaging device may be guided by audio or visual feedback, based on location tracking of the device. The movement of the imaging device may be constrained by a mechanical guiding structure toward the second image.

The stereoscopic display of the scene may be displayed in real time as the imaging device is moved to obtain the second image; and the first image is selected from previously recorded sequence of images based on a positional requirement for the stereoscopic display and the second viewpoint.

In one embodiment, the viewpoints of the imaging device are tracked and recorded for the selection of the image that can be paired with the current image. The movement of the imaging device may be constrained by a mechanical guiding structure to allow the selection of an image that is in the vicinity of a desired viewpoint for the stereoscopic display. In one embodiment, the movement of the imaging device relative to the mechanical guiding structure is automated.

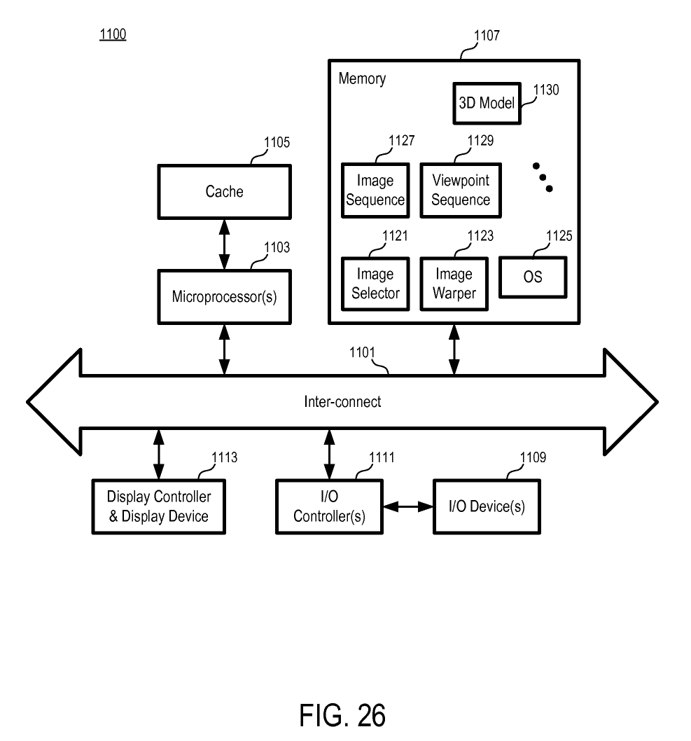

FIG. 26 shows a block diagram example of a data processing system for generating stereoscopic views in image guided procedures according to one embodiment of the present invention.

While FIG. 26 illustrates various components of a computer system, it is not intended to represent any particular architecture or manner of interconnecting the components. Other systems that have fewer or more components may also be used with the present invention.

In FIG. 26, the computer system (1100) is a form of a data processing system. The system (1100) includes an inter-connect (1101) (e.g., bus and system core logic), which interconnects a microprocessor(s) (1103) and memory (1107). The microprocessor (1103) is coupled to cache memory (1105), which may be implemented on a same chip as the microprocessor (1103).

The inter-connect (1101) interconnects the microprocessor(s) (1103) and the memory (1107) together and also interconnects them to a display controller and display device (1113) and to peripheral devices such as input/output (I/O) devices (1109) through an input/output controller(s) (1111). Typical I/O devices include mice, keyboards, modems, network interfaces, printers, scanners, video cameras and other devices.

The inter-connect (1101) may include one or more buses connected to one another through various bridges, controllers and/or adapters. In one embodiment the I/O controller (1111) includes a USB (Universal Serial Bus) adapter for controlling USB peripherals, and/or an IEEE-1394 bus adapter for controlling IEEE-1394 peripherals. The inter-connect (1101) may include a network connection.

The memory (1107) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The memory (1107) may stores an operating system (1115), an image selector (1121) and/or an image warper (1123) for generating stereoscopic display during an image guided procedure. Part of the selector and/or the warper may be implemented using hardware circuitry for improved performance. The memory (1107) may include a 3D model (1130) for the generation of virtual images. The 3D model (1130) can further be used by the image warper (1123) to determine the warping property between an already obtained image having one viewpoint and a desired image having another viewpoint, based on the position mapping of a set of points of the 3D model. The 3D model may be generated from scanned volumetric image data.

The memory (1107) may further store the image sequence (1127) of the real world images captured in real time during the image guided procedure and the viewpoint sequence (1129), which can be used by the image selector (1121) to select pairs of images for the generation of stereoscopic display. The selected images may be further corrected by the image warper (1123) to the desired viewpoints. In one embodiment, the memory (1107) caches a recent period of video images for selection by the image selector (1121). Alternatively, the system may use the most recent image, without using prior recorded images, for real time display.

The processor (1103) may augment the real world images with virtual objects (e.g., based on the 3D model (1130)).

Embodiments of the present invention can be implemented using hardware, programs of instruction, or combinations of hardware and programs of instructions.

In general, routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While some embodiments of the invention have been described in the context of fully functioning computers and computer systems, those skilled in the art will appreciate that various embodiments of the invention are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method for generating a stereoscopic view, comprising:
determining a warping map between two views of a scene;
obtaining a first image of the scene in one of the two views; and
transforming the first image of the scene into a second image of the scene according to the warping map between the two views of the scene.

2. The method of claim 1, wherein said determining the warping map comprises determining position differences of sampled points in two images corresponding to the two views.

3. The method of claim 2, wherein the sampled points are part of a three dimensional model of the scene.

4. The method of claim 3, wherein the sampled points are selected according to pre-defined points in an image of the scene.

5. The method of claim 4, wherein the pre-defined points correspond to regular grids in the first image of the scene.

6. The method of claim 1, wherein said transforming comprises:
transforming the first image into the second image using a texture mapping function of a graphics processor.

7. The method of claim 1, further comprising:
combining the first and second images for a stereoscopic display of the scene.

8. The method of claim 1, further comprising:
transforming the first image of the scene into a third image of the scene according to a further warping map between two views of the scene; and
generating a stereoscopic display of the scene using the second and third images of the scene.

9. The method of claim 8, wherein said generating the stereoscopic display of the scene comprises:
combining the second and third images of the scene to generate an anaglyph image of the scene.

10. The method of claim 8, further comprising:
receiving the first image from an imaging device;
determining viewpoints of the second and third images according to a viewpoint of the first image;
wherein the viewpoints of the second and third images are symmetric with respect to the viewpoint of the first image.

11. The method of claim 10, wherein said generating the stereoscopic display of the scene comprises:
augmenting the second and third images with virtual models.

12. The method of claim 10, wherein the first image is received during a neurosurgical procedure.

13. The method of claim 10, wherein the imaging device is mounted on a probe.

14. The method of claim 13, wherein a viewpoint of the imaging device is along the probe; and the viewpoints of the second and third images converge at a point in front of the probe.

15. The method of claim 10, wherein the imaging device comprises one of: a camera, an endoscope, and a microscope.

16. The method of claim 10, further comprising:
determining a position and orientation of the imaging device; and
determining the viewpoint of the first image based on the position and orientation of the imaging device.

17. The method of claim 10, wherein the scene includes a patient; and the mapping is based at least in part on a model of the patient.

18. The method of claim 1, further comprising:
receiving the first image from a video camera during a surgical procedure;
augmenting the first and second images with virtual models; and
generating an anaglyph image of the scene using the augmented first and second images.

19. A method, comprising:
receiving a first image and a second image of a scene during a surgical procedure, wherein a position and orientation of an imaging device is at least partially changed to capture the first and second images from different viewpoints; and
generating a stereoscopic display of the scene using the first and second images.

20. The method of claim 19, wherein the imaging device includes a probe; and the scene includes a portion of the probe and a portion of a patient.

21. The method of claim 20, further comprising:
providing an indication to guide the imaging device toward a location to take the second image, after the first image is captured.

22. The method of claim 21, wherein the indication comprises at least one of:
visual cue and audio cue.

23. The method of claim 20, further comprising:
receiving an input when the first image is captured;
in response to the input, identifying a location of the imaging device at which the first image is captured from position tracking data;
determining a target location of the imaging device, based on a stereoscopic viewpoint requirement and the identified location of the imaging device; and
providing an indication to guide the imaging device to the target location.

24. The method of claim 20, further comprising:
receiving a sequence of images from the imaging device during a surgical procedure, including the first and second images;
determining viewpoints of the sequence of images;
identifying at least one of the first and second images according to a stereoscopic viewpoint requirement and the viewpoints to generate the stereoscopic display.

25. The method of claim 24, wherein the imaging device is mounted on a probe;
and the probe is constrained by a mechanical guiding structure.

26-29. (canceled)

30. An apparatus, comprising:
an imaging device; and
a guiding structure coupled with the imaging device to constrain movement to change a viewpoint of the imaging device according to a path.

31. The apparatus of claim 30, wherein the imaging device comprises a probe and a micro video camera.

32. The apparatus of claim 30, further comprising a probe coupled with the guiding structure and the imaging device, the probe to be movable along the path with respect to the guiding structure.

33. The apparatus of claim 30, further comprises a motor to move the imaging device along the path relative to the guiding structure.

34. A machine readable media embodying instructions, the instructions causing a machine to perform a method, the method comprising:
transforming a first image of a scene into a second image of the scene according to a mapping between two views of the scene.

35. A machine readable media embodying instructions, the instructions causing a machine to perform a method, the method comprising:
receiving a first image and a second image of a scene during a surgical procedure, wherein a position and orientation of an imaging device is at least partially changed to capture the first and second images from different viewpoints; and
generating a stereoscopic display of the scene using the first and second images.

36. A machine readable media embodying data generated from executing instructions, the instructions causing a machine to perform a method, the method comprising:
transforming a first image of a scene into a second image of the scene according to a mapping between two views of the scene.

37. A machine readable media embodying data generated from executing instructions, the instructions causing a machine to perform a method, the method comprising:
generating a stereoscopic display of the scene using a first image and a second image of a scene during a surgical procedure;
wherein a position and orientation of an imaging device is at least partially changed to capture the first and second images from different viewpoints.

38. The media of claim 37, wherein each of the first image and the second image captures a portion of an imaging device.

39. The media of claim 38, wherein the portion of the imaging device comprises a tip of a probe.

40. A system, comprising:
means for obtaining a first image of a scene; and
means for transforming the first image into a second image of the scene according to a mapping between two views of the scene.

41. A system, comprising:
means for obtaining a first image and a second image of a scene during a surgical procedure, wherein a location of an imaging device is at least partially changed to capture the first and second images from different viewpoints; and
means for generating a stereoscopic display of the scene using the first and second images.

42. A data processing system, comprising:
memory; and
one or more processors coupled to the memory, the one or more processors to transform a first image of a scene into a second image of the scene according to a mapping between two views of the scene.

43. A data processing system, comprising:
one or more processors coupled to the memory, the one or more processors to generate a stereoscopic display of the scene using a first image and a second image of a scene during a surgical procedure;
wherein a position and orientation of an imaging device is at least partially changed to capture the first and second images from different viewpoints.

44. A system, comprising:
an imaging device;
a position tracking system to track a location of the imaging device; and
a computer coupled to the position tracking system and the imaging device, the computer to transform a first image of a scene obtained from the imaging device into a second image of the scene according to a mapping between two views of the scene.

45. A system, comprising:
an imaging device;
a position tracking system to track a location of the imaging device; and
a computer coupled to the position tracking system and the imaging device, the computer to generate a stereoscopic display of the scene using a first image and a second image of a scene during a surgical procedure;
wherein a position and orientation of an imaging device is at least partially changed to capture the first and second images from different viewpoints.
